(19) United States
(12) Patent Application Publication
(10) Pub. No.: US 2025/0373663 A1
(43) Pub. Date: Dec. 4, 2025

(54) SECURITY ASSOCIATION (SA) PLOTTING SYSTEM AND METHOD

(71) Applicant: Dell Products L.P., Round Rock, TX (US)

(72) Inventor: Cristian Manuel, Escondido, CA (US)

(73) Assignee: Dell Products L.P., Round Rock, TX (US)

(21) Appl. No.: 18/731,577

(22) Filed: Jun. 3, 2024

(51) Int. Cl. H04L 9/40

(52) U.S. Cl. CPC H04L 63/20; H04L 63/1425

(57) ABSTRACT

Embodiments of the present disclosure provide a security association (SA) plotting system and method that generates a graph of the SAs in a cluster for clearly indicating any issues in an IPsec implementation. According to one embodiment an Information Handling System (IHS) includes executable code to obtain log records associated with multiple Security Associations (SAs) that provide intercommunication among the nodes of the cluster, correlate the log records according to their IP address information, and generate a line graph that visually represents the SAs using a plurality of SA identifiers (SA IDs). Each log record includes information about an event associated with its associated SA. Additionally, the SAs conform to an IP Security (IPsec) protocol.

### BACKGROUND

As the value and use of information continues to increase, individuals and businesses seek additional ways to process and store information. One option available to users is Information Handling Systems (IHSs). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Modern day computing resources are provided by large computing environments that may include server farms, computer clusters, individual computing devices, and/or data centers. Computing environments are generally associated with large organizations, such as business enterprises to educational institutions such as universities. In many cases, larger organizations may manage multiple server farms over a diverse geographical region. Nevertheless, management of such large, diversified computing environments are typically provided by a remotely configured system management consoles. Openmanage Enterprise is one example of a system management console provided by Dell Technologies, which cost-effectively facilitates comprehensive lifecycle management for the hardware components of distributed computing environments from one console.

These large computing environments have become an increasingly important aspect of the current economy. Among the advantages of such computing environments are their ability to handle a variety of different computing scenarios including large computational problems, high volume data processing situations, and high availability (HA) situations. Such distributed computing systems typically utilize numerous hardware components in support of the computing environment. Additionally, in an effort to aggregate such hardware components and to make them more manageable and flexible, systems managers are often used to coordinate the operation of such numerous devices.

### SUMMARY

Embodiments of the present disclosure provide a security association (SA) plotting system and method that generates a graph of the SAs in a cluster for clearly indicating any issues in an IPsec implementation. According to one embodiment an Information Handling System (IHS) includes executable code to obtain log records associated with multiple Security Associations (SAs) that provide intercommunication among the nodes of the cluster, correlate the log records according to their IP address information, and generate a line graph that visually represents the SAs using a plurality of SA identifiers (SA IDs). Each log record includes information about an event associated with its associated SA. Additionally, the SAs conform to an IP Security (IPsec) protocol.

According to another embodiment, a security association (SA) plotting method includes the steps of obtaining a plurality of log records associated with a plurality of Security Associations (SAs) that provide intercommunication among a plurality of nodes configured in a cluster in which each log record including information about an event associated with its associated SA, wherein the SAs conform to an IP Security (IPsec) protocol, correlating the log records according to their IP address information, the IP address information uniquely identifying each node in the cluster, and generating a line graph that visually represents the SAs using a plurality of SA identifiers (SA IDs).

According to yet another embodiment, an Internet Protocol Security (IPsec) tool include computer-executable memory to obtain a plurality of log records associated with a plurality of Security Associations (SAs) that provide intercommunication among a plurality of nodes configured in a cluster, each log record including information about an event associated with its associated SA, wherein the SAs conform to an IP Security (IPsec) protocol, correlate the log records according to their IP address information, the IP address information uniquely identifying each node in the cluster, and generate a line graph that visually represents the SAs using a plurality of SA identifiers (SA IDs).

### BRIEF DESCRIPTION OF THE DRAWINGS

The present invention(s) is/are illustrated by way of example and is/are not limited by the accompanying figures. Elements in the figures are illustrated for simplicity and clarity, and have not necessarily been drawn to scale.

FIG. 1 is a block diagram illustrating certain components of a chassis comprising one or more compute sleds and one or more storage sleds that may be configured to provide a security association (SA) plotting system according to one embodiment of the present disclosure.

FIG. 2 shows an example of an IHS configured to implement systems and methods described herein for supporting the security association (SA) plotting system.

FIG. 3 is a diagram view illustrating several components of an example security association (SA) plotting system according to one embodiment of the present disclosure.

FIGS. 4A, 4B, and 4C illustrate example graphs that may be generated by the IPsec tool according to certain embodiments of the present disclosure.

FIG. 5 illustrates a flowchart depicting certain steps of one embodiment of a SA plotting method according to one embodiment of the present disclosure.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

Currently implemented computing environments, such as one implemented with a MX-7000 computing chassis provided by Dell Technologies, may include a large quantity of hardware components. For example, a fully scaled configuration of the MX-7000 may have up to 160 sleds and 24 I/O modules configured in 20 chassis. Furthermore each of the sleds is often configured with multiple individual hardware components. Secure communication among each of the components is often provided using Internet Protocol Security (IPsec). In general, IPsec (IP security) is a set of protocols for secure communication. One example of an IPsec tool is STRONGSWAN. STRONGSWAN may be particularly useful because it is widely used and has numerous configuration options.

Internet Key Exchange (IKE) is an IPsec protocol used to derive key material and establish a secure connection between two endpoints. Each secure connection includes two security associations (SAs) also known as security tunnels. A first SA (e.g., IKE_SA) is for management traffic like keep-alive, dead-peer detection, termination packets, while the second (e.g., CHILD_SA) is for actual user traffic like emails, video streams, and the like.

Nevertheless, secure communication among each of the components can become unwieldy with IPsec tools such as STRONGSWAN. For instance, STRONGSWAN issues may cause several outages of workflows at once because it controls most intra-node connections, which may result in numerous bug reports from each of these workflows. Although a single issue may have caused the outages, they may look like different issues because the workflows often have different use-cases. When this occurs, STRONGSWAN often generates an overwhelming number of logs, which often cannot be further reduced as they are needed to indicate each specific connection. Additionally, fixing the issue can take a long time and is error prone as all the correlations must be done manually. Log parsing tools, such as WANGDU help identify duplicates, but the correlation functionality is limited. As will be described in detail herein below, embodiments of the present disclosure provide a security association (SA) plotting system and method that generates a graph of the SAs in a cluster for clearly indicating any issues in the IPsec implementation.

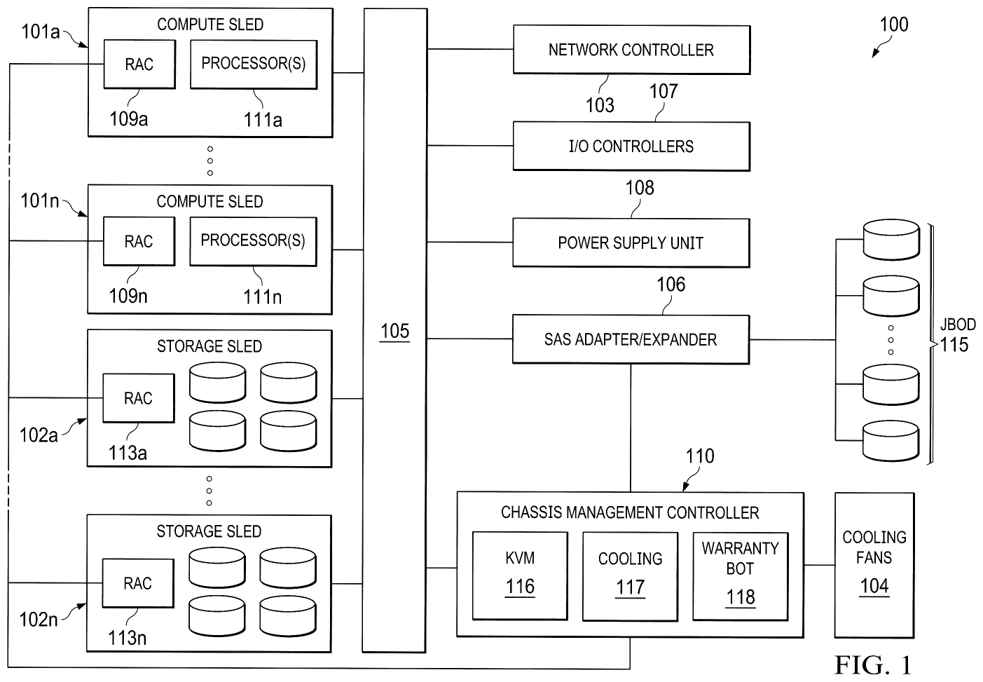

FIG. 1 is a block diagram illustrating certain components of a chassis 100 comprising one or more compute sleds 101a-n and one or more storage sleds 102a-n that may be configured to implement the systems and methods described herein. As described in additional detail below, each of the sleds 101a-n, 102a-n may be separately licensed hardware components and each of the sleds may also operate using a variety of licensed hardware and software features. Chassis 100 may include one or more bays that each receive an individual sled (that may be additionally or alternatively referred to as a tray, blade, and/or node), such as compute sleds 101a-n and storage sleds 102a-n. Chassis 100 may support a variety of different numbers (e.g., 4, 8, 16, 32), sizes (e.g., single-width, double-width), and physical configurations of bays. Other embodiments may include additional types of sleds that provide various types of storage and/or processing capabilities. Other types of sleds may provide power management and networking functions. Sleds may be individually installed and removed from the chassis 100, thus allowing the computing and storage capabilities of a chassis to be reconfigured by swapping the sleds with different types of sleds, in many cases without affecting the operations of the other sleds installed in the chassis 100.

By configuring a chassis 100 with different sleds, the chassis may be adapted to support specific types of operations, thus providing a computing solution that is directed toward a specific type of computational task. For instance, a chassis 100 that is configured to support artificial intelligence computing solutions may include additional compute sleds, compute sleds that include additional processors, and/or compute sleds that include specialized artificial intelligence processors or other specialized artificial intelligence components, such as specialized FPGAs. In another example, a chassis 100 configured to support specific data mining operations may include network controllers 103 that support high-speed couplings with other similarly configured chassis, thus supporting high-throughput, parallel-processing computing solutions.

In another example, a chassis 100 configured to support certain database operations may be configured with specific types of storage sleds 102a-n that provide increased storage space or that utilize adaptations that support optimized performance for specific types of databases. In other scenarios, a chassis 100 may be configured to support specific enterprise applications, such as by utilizing compute sleds 101a-n and storage sleds 102a-n that include additional memory resources that support simultaneous use of enterprise applications by multiple remote users. In another example, a chassis 100 may include compute sleds 101a-n and storage sleds 102a-n that support secure and isolated execution spaces for specific types of virtualized environments. In some instances, specific combinations of sleds may comprise a computing solution, such as an artificial intelligence system, which may be licensed and supported as a computing solution.

Multiple chassis 100 may be housed within a rack. Data centers may utilize large numbers of racks, with various different types of chassis installed in the various rack configurations. The modular architecture provided by the sleds, chassis, and rack allow for certain resources, such as cooling, power, and network bandwidth, to be shared by the compute sleds 101a-n and the storage sleds 102a-n, thus providing efficiency improvements, and supporting greater computational loads.

Chassis 100 may be installed within a rack structure that provides all or part of the cooling utilized by chassis 100. For airflow cooling, a rack may include one or more banks of cooling fans that may be operated to ventilate heated air away from a chassis 100 that is housed within a rack. Chassis 100 may alternatively or additionally include one or more cooling fans 104 that may be similarly operated to ventilate heated air from within the sleds 101a-n, 102a-n installed within the chassis. A rack and a chassis 100 installed within the rack may utilize various configurations and combinations of cooling fans 104 to cool the sleds 101a-n, 102a-n and other components housed within chassis 100.

Sleds 101a-n, 102a-n may be individually coupled to chassis 100 via connectors. The connectors may correspond to bays provided in the chassis 100 and may physically and electrically couple an individual sled 101a-n, 102a-n to a backplane 105. Chassis backplane 105 may be a printed circuit board that includes electrical traces and connectors that are configured to route signals between the various components of chassis 100. In various embodiments, backplane 105 may include various additional components, such as cables, wires, midplanes, backplanes, connectors, expansion slots, and multiplexers. In certain embodiments, backplane 105 may be a motherboard that includes various electronic components installed thereon. In some embodiments, components installed on a motherboard-type backplane 105 may include components that implement all or part of the functions described with regard to components such as network controller 103, SAs (Serial Attached SCSI) adapter/expander 106, I/O controllers 107, and power supply unit 108.

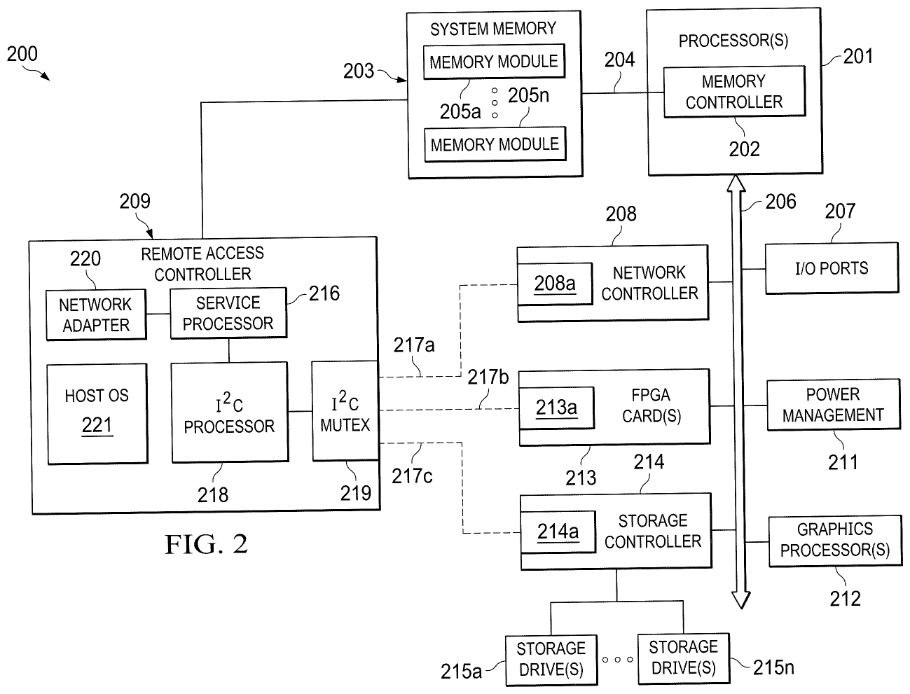

In certain embodiments, a compute sled 101a-n may be an IHS, such as described with regard to IHS 200 of FIG. 2. A compute sled 101a-n may provide computational processing resources that may be used to support a variety of e-commerce, multimedia, business, and scientific computing applications. In some cases, these applications may be provided as services via a cloud implementation. Compute sleds 101a-n are typically configured with hardware and software that provide leading-edge computational capabilities. Accordingly, services provided using such computing capabilities are typically provided as high-availability systems that operate with minimum downtime. Compute sleds 101a-n may be configured for general-purpose computing or may be optimized for specific computing tasks in support of specific computing solutions. A compute sled 101a-n may be a licensed component of a data center and may also operate using various licensed hardware and software systems.

As illustrated, each compute sled 101a-n includes a remote access controller (RAC) 109a-n. As described in additional detail with regard to FIG. 2, a remote access controller 109a-n provides capabilities for remote monitoring and management of each compute sled 101a-n. In support of these monitoring and management functions, remote access controllers 109a-n may utilize both in-band and sideband (i.e., out-of-band) communications with various internal components of a compute sled 101a-n and with other components of chassis 100. Remote access controller 109a-n may collect sensor data, such as temperature sensor readings, from components of the chassis 100 in support of airflow cooling of the chassis 100 and the sleds 101a-n, 102a-n. Also as described in additional detail with regard to FIG. 2, remote access controllers 109a-n may support communications with chassis management controller 110 where these communications may report on the status of hardware and software systems on a particular sled 101a-n, 102a-n, such as information regarding warranty coverage for a particular hardware and/or software system.

A compute sled 101a-n may include one or more processors 111a-n that support specialized computing operations, such as high-speed computing, artificial intelligence processing, database operations, parallel processing, graphics operations, streaming multimedia, and/or isolated execution spaces for virtualized environments. Using such specialized processor capabilities of a compute sled 101a-n, a chassis 100 may be adapted for a particular computing solution.

In some embodiments, each compute sled 101a-n may include a storage controller that may be utilized to access storage drives that are accessible via chassis 100. Some of the individual storage controllers may provide support for RAID (Redundant Array of Independent Disks) configurations of logical and physical storage drives, such as storage drives provided by storage sleds 102a-n. In some embodiments, some or all of the individual storage controllers utilized by compute sleds 101a-n may be HBAs (Host Bus Adapters) that provide more limited capabilities in accessing physical storage drives provided via storage sleds 102a-n and/or via SAS adapter/expander 106.

As illustrated, chassis 100 also includes one or more storage sleds 102a-n that are coupled to the backplane 105 and installed within one or more bays of chassis 100 in a similar manner to compute sleds 101a-n. Each of the individual storage sleds 102a-n may include various different numbers and types of storage devices. For instance, storage sleds 102a-n may include SAS (Serial Attached SCSI) magnetic disk drives, SATA (Serial Advanced Technology Attachment) magnetic disk drives, solid-state drives (SSDs), and other types of storage drives in various combinations. The storage sleds 102a-n may be utilized in various storage configurations by the compute sleds 101a-n that are coupled to chassis 100. As illustrated, each storage sled 102a-n may include a remote access controller (RAC) 113a-n. Remote access controllers 113a-n may provide capabilities for remote monitoring and management of storage sleds 102a-n in a similar manner to the remote access controllers 109a-n in compute sleds 101a-n.

In addition to the data storage capabilities provided by storage sleds 102a-n, chassis 100 may provide access to other storage resources 115 that may be installed as components of chassis 100 and/or may be installed elsewhere within a rack housing the chassis 100, such as within a storage blade. In certain scenarios, storage resources 115 may be accessed via SAS adapter/expander 106 that is coupled to backplane 105 of chassis 100. For example, SAS adapter/expander 106 may support connections to a number of JBOD (Just a Bunch Of Disks) storage drives 115 that may be configured and managed individually and without implementing data redundancy across the various drives 115. The additional drives 115 may also be at various other locations within the data center in which chassis 100 is installed. Such additional storage resources 115 may also be remotely located from chassis 100.

As illustrated, the chassis 100 of FIG. 1 includes a network controller 103 that provides network access to the sleds 101a-n, 102a-n installed within the chassis. Network controller 103 may include various switches, adapters, controllers, and couplings used to connect chassis 100 to a network, either directly or via additional networking components and connections provided via a rack in which chassis 100 is installed. In some embodiments, network controllers 103 may be replaceable components that include capabilities that support certain computing solutions, such as network controllers 103 that interface directly with network controllers from other chassis in support of clustered processing capabilities that utilize resources from multiple chassis.

Chassis 100 may also include a power supply unit 108 that provides the components of the chassis with various levels of DC power from an AC power source or from power delivered via a power system provided by the rack within which chassis 100 is installed. In certain embodiments, power supply unit 108 may be implemented within a sled that may provide chassis 100 with redundant, hot-swappable power supply units. In such embodiments, power supply unit 108 is a replaceable component that may be used in support of certain computing solutions.

Chassis 100 may also include various I/O controllers 107 that may support various I/O ports, such as USB ports that may be used to support keyboard and mouse inputs and/or video display capabilities. I/O controllers 107 may be utilized by a chassis management controller 110 to support various KVM (Keyboard, Video and Mouse) 116 capabilities that provide administrators with the ability to interface with the chassis 100.

In addition to providing support for KVM 116 capabilities for administering chassis 100, chassis management controller 110 may support various additional functions for sharing the infrastructure resources of chassis 100. In some scenarios, chassis management controller 110 may implement tools for managing the network controller 103, power supply unit 108, and airflow cooling 104 that are available via the chassis 100. As described, the cooling fans 104 utilized by chassis 100 may include an airflow cooling system that is provided by a rack in which the chassis 100 may be installed and managed by a cooling module 117 of the chassis management controller 110.

As described, components of chassis 100 such as compute sleds 101a-n and storage sleds 102a-n may include remote access controllers 109a-n, 113a-n that may collect information regarding the warranties for hardware and software systems on each sled. Chassis management controller 110 may similarly collect and report information regarding the warranties for hardware and software systems on each sled.

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. As described, an IHS may also include one or more buses operable to transmit communications between the various hardware components. An example of an IHS is described in more detail with respect to FIG. 2.

IHSs 200 may be used to support a variety of e-commerce, multimedia, business, and scientific computing applications. In some cases, these applications may be provided as services via a cloud implementation. IHSs 200 are typically configured with hardware and software that provide leading-edge computational capabilities. IHSs 200 may also support various numbers and types of storage devices. Accordingly, services provided using such computing capabilities are typically provided as high-availability systems that operate with minimum downtime. The warranties provided by vendors of IHSs 200 and the related hardware and software allow the data centers 101a-d to provide contracted Service Level Agreement (SLA) to customers. Upon failure of an IHS 200, compute sleds and storage sleds 102 typically relies on a vendor to provide warranty support in order to maintain contracted SLAs.

FIG. 2 illustrates an example IHS 200 configured to implement the systems and methods described herein. It should be appreciated that although the embodiments described herein may describe an IHS that is a compute sled or similar computing component that may be deployed within the bays of a chassis, other embodiments may be utilized with other types of IHSs. In the illustrative embodiment of FIG. 2, IHS 200 may be a computing component, such as compute sled 101a-n, that is configured to share infrastructure resources provided by a chassis 100 in support of specific computing solutions.

IHS 200 may be a compute sled that is installed within a large system of similarly configured IHSs that may be housed within the same chassis, rack and/or data center. IHS 200 may utilize one or more processors 201. In some embodiments, processors 201 may include a main processor and a co-processor, each of which may include a plurality of processing cores that, in certain scenarios, may each be used to run an instance of a server process. In certain embodiments, one, some or all processor 201 may be graphics processing units (GPUs). In some embodiments, one, some or all processor 201 may be specialized processors, such as artificial intelligence processors adapted to support high-throughput parallel processing computations. As described, such specialized adaptations of IHS 200 may be used to implement specific computing solutions supported by the chassis in which IHS 200 is installed.

As illustrated, processor 201 includes an integrated memory controller 202 that may be implemented directly within the circuitry of the processor 201, or memory controller 202 may be a separate integrated circuit that is located on the same die as the processor 201. Memory controller 202 may be configured to manage the transfer of data to and from a system memory 203 of the IHS 200 via a high-speed memory interface.

System memory 203 is coupled to processor 201 via a memory bus 204 that provides the processor 201 with high-speed memory used in the execution of computer program instructions by the processor 201. Accordingly, system memory 203 may include memory components, such as static RAM (SRAM), dynamic RAM (DRAM), or NAND Flash memory, suitable for supporting high-speed memory operations by the processor 201. In certain embodiments, system memory 203 may combine both persistent, non-volatile memory, and volatile memory.

In certain embodiments, system memory 203 may be comprised of multiple removable memory modules. System memory 203 in the illustrated embodiment includes removable memory modules 205a-n. Each of the removable memory modules 205a-n may correspond to a printed circuit board memory socket that receives a removable memory module 205a-n, such as a DIMM (Dual In-line Memory Module), that can be coupled to the socket and then decoupled from the socket as needed, such as to upgrade memory capabilities or to replace faulty components. Other embodiments of IHS system memory 203 may be configured with memory socket interfaces that correspond to different types of removable memory module form factors, such as a Dual In-line Package (DIP) memory, a Single In-line Pin Package (SIPP) memory, a Single In-line Memory Module (SIMM), and/or a Ball Grid Array (BGA) memory.

IHS 200 may utilize a chipset that may be implemented by integrated circuits that are connected to each processor 201. All or portions of the chipset may be implemented directly within the integrated circuitry of an individual processor 201. The chipset may provide the processor 201 with access to a variety of resources accessible via one or more buses 206. Various embodiments may utilize any number of buses to provide the illustrated pathways served by bus 206. In certain embodiments, bus 206 may include a PCIe (PCI Express) switch fabric that is accessed via a PCIe root complex. IHS 200 may also include one or more I/O ports 207, such as PCIe ports, which may be used to couple the IHS 200 directly to other IHSs, storage resources or other peripheral components. In certain embodiments, the I/O ports 207 may provide couplings to the backplane of the chassis in which the IHS 200 is installed.

As illustrated, a variety of resources may be coupled to the processor 201 of the IHS 200 via bus 206. For instance, processor 201 may be coupled to a network controller 208, such as provided by a Network Interface Controller (NIC) that is coupled to the IHS 200 and allows the IHS 200 to communicate via an external network, such as the Internet or a LAN. As illustrated, network controller 208 may report information to a remote access controller 209 via an out-of-band signaling pathway that is independent of the operating system of the IHS 200.

Processor 201 may also be coupled to a power management unit 211 that may interface with power system unit 108 of chassis 100 in which an IHS 200, such as a compute sled 101a-n, may be installed. In certain embodiments, a graphics processor 212 may be comprised within one or more video or graphics cards, or an embedded controller, installed as components of IHS 200. In certain embodiments, graphics processor 212 may be an integrated part of the remote access controller 209 and may be utilized to support the display of diagnostic and administrative interfaces related to IHS 200 via display devices that are coupled, either directly or remotely, to remote access controller 209.

As illustrated, IHS 200 may include one or more FPGA (Field-Programmable Gate Array) card(s) 213. Each of the FPGA cards 213 supported by IHS 200 may include various processing and memory resources, in addition to an FPGA integrated circuit that may be reconfigured after deployment of IHS 200 through programming functions supported by FPGA card 213. Each individual FGPA card 213 may be optimized to perform specific processing tasks, such as specific signal processing, security, data mining, and artificial intelligence functions, and/or to support specific hardware coupled to IHS 200. In certain embodiments, such specialized functions supported by an FPGA card 213 may be utilized by IHS 200 in support of certain computing solutions. As illustrated, FPGA 213 may report information to the remote access controller 209 via an out-of-band signaling pathway that is independent of the operating system of the IHS 200.

IHS 200 may also support one or more storage controllers 214 that may be utilized to provide access to virtual storage configurations. For instance, storage controller 214 may provide support for RAID (Redundant Array of Independent Disks) configurations of storage devices 215a-n, such as storage drives provided by storage sleds 102a-n and/or JBOD 115 of FIG. 1. In some embodiments, storage controller 214 may be an HBA (Host Bus Adapter). Storage controller 214 may report information to the remote access controller 209 via an out-of-band signaling pathway that is independent of the operating system of the IHS 200.

In certain embodiments, IHS 200 may operate using a BIOS (Basic Input/Output System) that may be stored in a non-volatile memory accessible by the processor(s) 201. The BIOS may provide an abstraction layer by which the operating system of the IHS 200 interfaces with the hardware components of the IHS. Upon powering or restarting IHS 200, processor 201 may utilize BIOS instructions to initialize and test hardware components coupled to the IHS, including both components permanently installed as components of the motherboard of IHS 200, and removable components installed within various expansion slots supported by the IHS 200. The BIOS instructions may also load an operating system for use by the IHS 200. In certain embodiments, IHS 200 may utilize Unified Extensible Firmware Interface (UEFI) in addition to or instead of a BIOS. In certain embodiments, the functions provided by a BIOS may be implemented, in full or in part, by the remote access controller 209.

In certain embodiments, remote access controller 209 may operate from a different power plane from the processors 201 and other components of IHS 200, thus allowing the remote access controller 209 to operate, and management tasks to proceed, while the processing cores of IHS 200 are powered off. As described, various functions provided by the BIOS, including launching the operating system of the IHS 200, may be implemented by the remote access controller 209. In some embodiments, the remote access controller 209 may perform various functions to verify the integrity of the IHS 200 and its hardware components prior to initialization of the IHS 200 (i.e., in a bare-metal state).

Remote access controller 209 may include a service processor 216, or specialized microcontroller, which operates management software that supports remote monitoring and administration of IHS 200. Remote access controller 209 may be installed on the motherboard of IHS 200 or may be coupled to IHS 200 via an expansion slot provided by the motherboard. In support of remote monitoring functions, network adapter 220 may support connections with remote access controller 209 using wired and/or wireless network connections via a variety of network technologies.

In some embodiments, remote access controller 209 may support monitoring and administration of various devices 208, 213, 214 of an IHS via a sideband interface. In such embodiments, the messages in support of the monitoring and management function may be implemented using MCTP (Management Component Transport Protocol) that may be transmitted using I2C sideband bus connections 217a-c established with each of the respective managed devices 208, 213, 214. As illustrated, the managed hardware components of the IHS 200, such as FPGA cards 213, network controller 208 and storage controller 214, are coupled to the IHS processor 201 via an in-line bus 206, such as a PCIe root complex, that is separate from the 12C sideband bus connection 217a-c.

In certain embodiments, the service processor 216 of remote access controller 209 may rely on an 12C co-processor 218 to implement sideband I2C communications between the remote access controller 209 and managed components 208, 213, 214 of the IHS. The I2C co-processor 218 may be a specialized co-processor or micro-controller that is configured to interface via a sideband I2C bus interface with the managed hardware components 208, 213, 214 of IHS. In some embodiments, the 12C co-processor 218 may be an integrated component of the service processor 216, such as a peripheral system-on-chip feature that may be provided by the service processor 216. Each I2C bus 217a-c is illustrated as single line in FIG. 2. However, each I2C bus 217a-c may be comprised of a clock line and data line that couple the remote access controller 209 to 12C endpoints 208a, 213a, 214a.

As illustrated, the 12C co-processor 218 may interface with the individual managed devices 208, 213, and 214 via individual sideband I2C buses 217a-c selected through the operation of an 12C multiplexer 219. Via switching operations by the 12C multiplexer 219, a sideband bus connection 217a-c may be established by a direct coupling between the 12C co-processor 218 and an individual managed device 208, 213, or 214.

In providing sideband management capabilities, the 12C co-processor 218 may interoperate with corresponding endpoint 12C controllers 208a, 213a, 214a that implement the I2C communications of the respective managed devices 208, 213, 214. The endpoint 12C controllers 208a, 213a, 214a may be implemented as a dedicated microcontroller for communicating sideband I2C messages with the remote access controller 209, or endpoint 12C controllers 208a, 213a, 214a may be integrated SoC functions of a processor of the respective managed device endpoints 208, 213, 214.

In various embodiments, an IHS 200 does not include each of the components shown in FIG. 2. In various embodiments, an IHS 200 may include various additional components in addition to those that are shown in FIG. 2. Furthermore, some components that are represented as separate components in FIG. 2 may in certain embodiments instead be integrated with other components. For example, in certain embodiments, all or a portion of the functionality provided by the illustrated components may instead be provided by components integrated into the one or more processor 201 as a systems-on-a-chip.

In some embodiments, the remote access controller 209 may include or may be part of a baseboard management controller (BMC). As a non-limiting example of a remote access controller 209, the integrated Dell Remote Access Controller (iDRAC) from Dell® is embedded within Dell PowerEdge™ servers and provides functionality that helps information technology (IT) administrators deploy, update, monitor, and maintain servers remotely. In other embodiments, chassis management controller 110 may include or may be an integral part of a baseboard management controller. Remote access controller 209 may be used to monitor, and in some cases manage computer hardware components of IHS 200. Remote access controller 209 may be programmed using a firmware stack that configures remote access controller 209 for performing out-of-band (e.g., external to a computer's operating system or BIOS) hardware management tasks. Remote access controller 209 may run a host operating system (OS) 221 on which various agents execute. The agents may include, for example, a service module that is suitable to interface with remote access controller 209 including, but not limited to, an iDRAC service module (iSM).

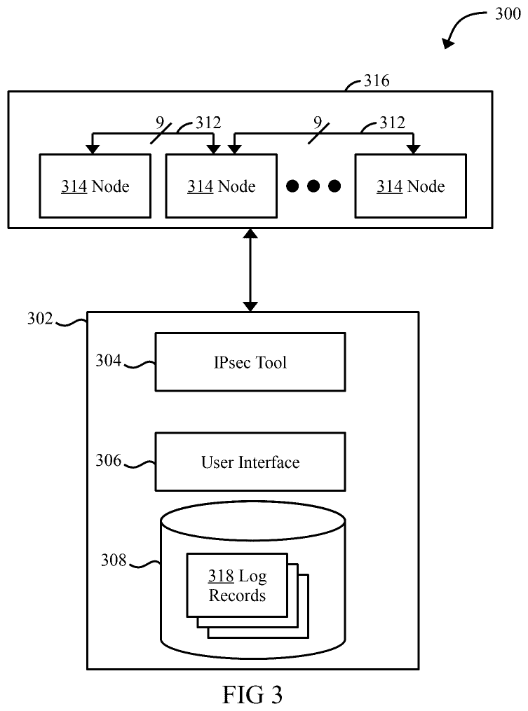

FIG. 3 is a diagram view illustrating several components of an example security association (SA) plotting system 300 according to one embodiment of the present disclosure. The SA plotting system 300 includes an HIS 302 that executes an IPsec tool 304 to manage SAs 312 established between the nodes 314 in a cluster 316. The IPsec tool 304 may also generate log records 318, which are then stored in a database 308 whenever an IPsec issue occurs, which is commonly referred to as a data collect (DC) event. Additionally, the SA plotting system 300 may display the graph on a user interface 306 for view by a user.

The nodes 314 may be any type. For example, the nodes 314 may each include an IHS 200 such as described above with reference to FIG. 2. As another example, the nodes 314 may each include a storage device or a virtual storage device configured on the storage sled 102a-n as described above with reference to FIG. 1. As yet another example, the nodes 314 may each include a processing device or a virtual compute device configured on the compute sled 101a-n as described above with reference to FIG. 1. The IPsec tool 304 may be any type that implements a secure network protocol suite. In one embodiment, the IPsec tool 304 may include the STRONGSWAN IPsec tool because it is widely used and has numerous configuration options.

In general, IPsec (IP security) is a set of protocols for secure communication. Internet Key Exchange (IKE) is an IPsec protocol used to derive key material and establish a secure connection between two nodes 314. Each secure connection includes two security associations (Sas) also known as secure tunnels. A first secure tunnel 312, namely an IKE_SA secure tunnel, is for management traffic like keep-alive, dead-peer detection, termination packets, and the like, while a second secure tunnel 312, the CHILD_SA secure tunnel is for actual user traffic like emails, video streams, and the like.

The IPsec tool 304 encrypts all communications between the nodes 314 in the cluster. There are typically up to nine IP addresses per node 314 (e.g., a cluster IP address, an appliance IP address, a node-A IP address, a node-B IP address, a Postgres IP address, a CP IP address, a NAS cluster IP address, a NAS node-A IP address, and a NAS node-B IP address) that are expected to establish SAs 312 with each other. Thus, as nodes 314 are added to the cluster 316, the number of SAs 312 grows substantially. Additionally, CHILD_SA secure tunnels 312 are renegotiated every hour, while IKE_SA secure tunnels 312 are renegotiated every four hours. Network failures and node reboots are among the many actions that can trigger SA issues or problems.

Given the IPsec structure described above, many SA issues, also known as DCs, often have an overwhelming number of SA events all happening simultaneously. In many cases, it takes hours to parse through all the SA logs to identify any root cause issues. According to embodiments of the present disclosure, the SA plotting system 300 provides techniques for identifying root cause issues in an IPsec event by parsing the log records 318 in a data collect (DC) event, correlating the log records 318 with IP data, and outputting a line graph visually representing each SA state obtained from the log records 318. Additionally, users can easily filter the log records 318 based on criteria, such as IP addresses, date/times, and various SA identifiers. The resulting graph allows users to see issues spanning large periods of time, and it makes explaining issues to outside teams easier. In one embodiment, the SA plotting system 300 may include logic to parse information included in the log records 318, match important keywords to correlate the SAs 312 with prior events, extract important fields (e.g., appliance names, IP addresses, unique IDs, dates, etc.), render the identified events using icons, such as will be described herein below.

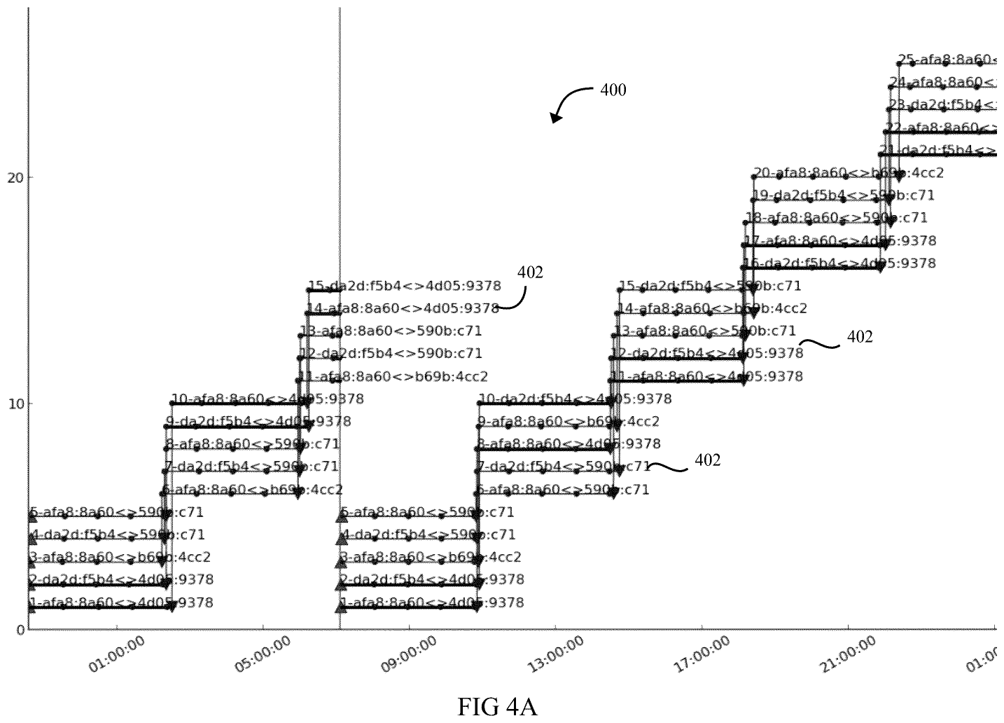

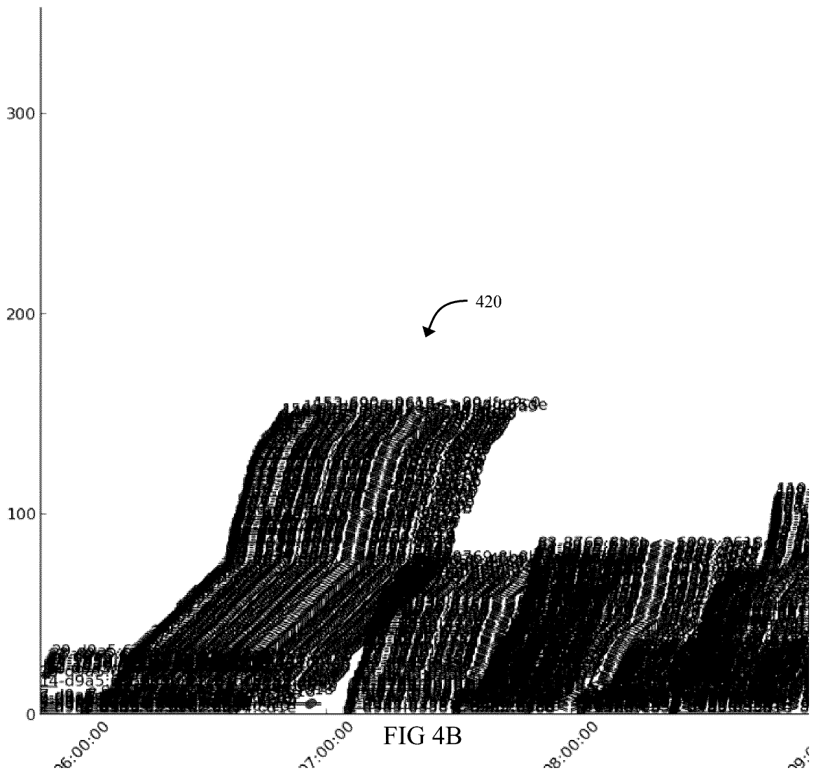

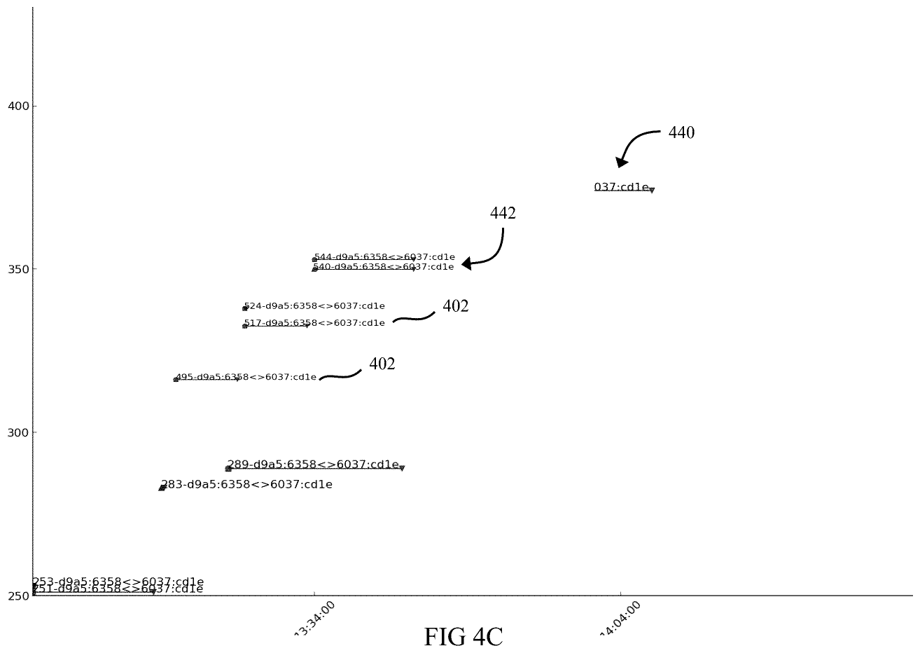

FIGS. 4A, 4B, and 4C illustrate example graphs 400, 420, and 440 that may be generated by the IPsec tool 304 according to certain embodiments of the present disclosure. In particular, FIG. 4A illustrates a graph 400 of the nodes 314 of a cluster 316 in which their SAs 312 are functioning normally, FIG. 4B illustrates a graph 420 in which their SAs 312 are functioning abnormally, and FIG. 4C illustrates a graph 440 in which the SA ID have been filtered. To generate the graphs 400, 420, and 440, the SA plotting system 300 reads the log records 318 that have occurred in a DC event sequentially, maps all unique IKE_SA identifiers to their IKEv2 events (e.g., initialization, up, teardown, down, timeout, heartbeat, etc.), and displays them in a color-coded graph. For each of the graphs 400, 420, and 440, time is represented by the X-axis, while the SA ID 402 is represented on the Y-axis as its own line. Each encryption tunnel/SA is assigned a unique ID, and each unique SA is responsible for a different set of traffic.

The graphs 400, 420, and 440 may include certain icons indicating certain events that have occurred with each SA 312. Each icon may be displayed proximate its respective SA ID 402. For example, an up arrow indicates that a connection has been initiated, while a down arrow indicates that a connection has been destroyed. The graph may also include other types of visual indicators to identify certain events that have occurred. For example, a yellow arrow means the SA 312 was started but not established, a green arrow means that the SA 312 was started and successfully established, a blue arrow means the event was accomplished gracefully, while a red arrow means the SA 312 experienced a timeout. A blue dot indicates a keep-alive message, while a green dot indicates a CHILD_SA rekey event. Additionally, a blue vertical line between two SAs indicate an IKE_SA rekey event, a black vertical line indicates a reboot of the SA 312, a purple line indicates a configuration issue, while a dashed vertical line indicates a service restart event. While the present embodiment is described using certain colors and/or shapes to indicate certain events, it should be understood that any suitable combination of colors and/or visual indicators may be used. For example, important events use larger icons and bolder colors, while less important events are smaller. Additionally, the tool allows the user to “zoom” in on issues. By allowing start_time, end_time, start_sa, and end_sa parameters, unnecessary pieces of the picture may be cropped out. This will spread the points of interest out, making the details (smaller icons) easier to see.

Referring to FIG. 4A, the graph 400 was generated from a multi-appliance setup with four nodes 314 with two name spaces each. The graph 400 shows all the SAs 312 starting around the same time, they all do a CHILD_SA rekey every hour, and the SA ID remains the same throughout this process. Additionally, all of the SAs 312 do an IKE_SA rekey every four hours, the SA ID is renewed every time this event occurs, thus yielding the ladder shape. The IKE_SA unique IDs are reset when the service restarts.

Referring now to FIG. 4B, graph 420 shows that the SAs 312 are experiencing several failures thus yielding an overwhelming number of log events. As shown, the quantity of SA events is relatively large, which is cumbersome for a healthy setup spanning such a short amount of time. As such, the SA plotting system 300 may be configured with filters so that the graph can be re-generated with specific parameters. The SA plotting system 300 may filter on any suitable criteria. For example, the SA plotting system 300 may filter the events in the graph 400, 420 based on node 314, SA identifiers, IP address, date/times, IKE_SA identifiers, a certain type of IKEv2 event, and the like.

FIG. 4C illustrates an example graph 440 in which the graph 420 of FIG. 4B was filtered based on a particular SA 312. As shown, the overwhelming number of SAs 312 have been removed in order to reveal the network service failure causing the problem. In particular, the problem involved a duplicate SA situation 442 where two identical SAs 312 started at the same time. That is, the source and destination IP addresses on both of the SAs 312 are the same, thus causing the large amount of events. Thus as can be seen, filtering the events in the graph may enable the user remove clutter in the graph in order to identify the source of the problem.

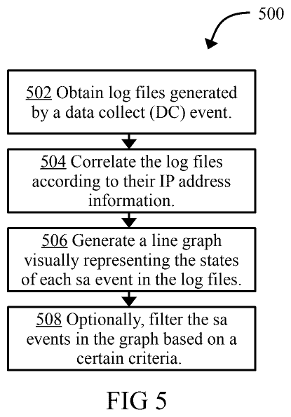

FIG. 5 illustrates a flowchart depicting certain steps of one embodiment of a SA plotting method 500 according to one embodiment of the present disclosure. In one embodiment, at least a portion of the steps of the method 500 may be performed by the IPsec tool 304. In another embodiment, the method 500 may be performed by a plugin that may be installed for use with the IPsec tool 304. The method 500 may be performed at any time that a user desires to view the connection history of the IPsec network over any desired period of time.

Initially, a DC event occurs to the SAs 312 in the IPsec network. As such, the method 500 obtains log records 318 generated by a data collect (DC) event at step 502. For example, the DC event may be based on a failure or issue with the SAs 312 configured in the cluster 316. Thereafter at step 504, the method 500 correlates the log records 318 according to their IP address information. In one embodiment, the method 500 may extract from the log records 318, certain information (e.g., SA establishments, SA tear downs, SA timeouts, SA keep-alives, SA rekeys, SA configuration problems, Service restarts, Node reboots, etc.) for each SA 312. Each event is mapped to a timestamp and IKE_SA unique ID.

At step 506, the method 500 generates a line graph 400, 420, 440 visually representing the states of each SA event in the log records 318, and displays the generated line graph on a display for view by a user. In one embodiment, the method 500 may generate and display icons representing certain events of each SA 312. For example, the method 500 may generate arrows next to an SA ID to indicate certain events about how the SA 312 was established or torn down, or dots proximate to an SA ID to indicate other useful event information (e.g., CHILD_SA rekeys, IKE_SA rekeys, keep-alive message, etc.) that the SA 312 may have encountered. At this point, the user may view the graph 400, 420, 440 to obtain information about how well the IPsec network is operating. Optionally, the method 500 may filter the SA IDs in the graph based on a certain criteria at step 508. For example, the method 500 may filter the log records 318 based on IP addresses, date/times, and various SA identifiers to, among other things, reduce the large quantity of SA IDs 402 shown on the display so that pertinent information useful to the user may be viewed.

The steps of the aforedescribed method may be repeatedly performed for generating a graph of the SAs 312 in an IPsec network. Nevertheless, when use of the SA plotting method 500 is no longer needed or desired, the process ends.

While FIG. 5 describes an example method that may be performed for displaying information about SAs 312, the features of the method 500 may be embodied in other specific forms without deviating from the spirit and scope of the present disclosure. For example, the method 500 may perform additional, fewer, or different operations than those described in the present examples. As another example, the sequence in which steps of the aforedescribed process may be performed should not be limited thereto as it is contemplated that in other embodiments, the disclosed steps may be performed in a different order or sequence without departing from the spirit and scope of the present disclosure.

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS) comprising:
a plurality of nodes configured in a cluster; and
at least one memory coupled to at least one processor, the at least one memory having program instructions stored thereon that, upon execution by the at least one processor, cause the IHS to:
obtain a plurality of log records associated with a plurality of Security Associations (SAs) that provide intercommunication among the nodes of the cluster, each log record including information about an event associated with its associated SA, wherein the SAs conform to an IP Security (IPsec) protocol;
correlate the log records according to their IP address information, the IP address information uniquely identifying each node in the cluster; and
generate a line graph that visually represents the SAs using a plurality of SA identifiers (SA IDs).

2. The IHS of claim 1, wherein the program instructions, upon execution, further cause IHS to obtain the plurality of log records in response to a Data Collect (DC) event.

3. The IHS of claim 1, wherein the program instructions, upon execution, further cause IHS to extract, from the log records, at least one of a SA establishment, a SA teardown, a SA timeout, a SA keep-alive message, a SA rekey event, a SA configuration problem, a Service restart, and a node reboot event.

4. The IHS of claim 1, wherein the program instructions, upon execution, further cause IHS to filter the log records according to a criteria comprising at least one of an IP address, a date/time stamp, or an SA identifier.

5. The IHS of claim 1, wherein the program instructions, upon execution, further cause IHS to generate an icon proximate to a SA ID, wherein the icon represents an event that the SA experienced.

6. The IHS of claim 5, wherein the program instructions, upon execution, further cause IHS to generate the icon according to how the SA was established or torn down.

7. The IHS of claim 5, wherein the program instructions, upon execution, further cause IHS to indicate event information that the SA has encountered.

8. The IHS of claim 7, wherein the event information is indicative of at least one of a CHILD_SA rekey event, an IKE_SA rekey event, or a keep-alive message.

9. The IHS of claim 1, wherein the program instructions are embodied as a plugin to an IPsec tool.

10. A security association (SA) plotting method comprising:
obtaining a plurality of log records associated with a plurality of Security Associations (SAs) that provide intercommunication among a plurality of nodes configured in a cluster, each log record including information about an event associated with its associated SA, wherein the SAs conform to an IP Security (IPsec) protocol;
correlating the log records according to their IP address information, the IP address information uniquely identifying each node in the cluster; and
generating a line graph that visually represents the SAs using a plurality of SA identifiers (SA IDs).

11. The SA plotting method of claim 10, further comprising obtaining the plurality of log records in response to a Data Collect (DC) event.

12. The SA plotting method of claim 10, further comprising extracting, from the log records, at least one of a SA establishment, a SA teardown, a SA timeout, a SA keep-alive message, a SA rekey event, a SA configuration problem, a Service restart, and a node reboot event.

13. The SA plotting method of claim 10, further comprising filtering the log records according to a criteria comprising at least one of an IP address, a date/time stamp, or a SA identifier.

14. The SA plotting method of claim 10, further comprising generating an icon proximate to a SA ID, wherein the icon represents an event that the SA experienced.

15. The SA plotting method of claim 14, further comprising generating the icon according to how the SA was established or torn down.

16. The SA plotting method of claim 15, further comprising indicating event information that the SA has encountered, wherein the event information is indicative of at least one of a CHILD_SA rekey event, an IKE_SA rekey event, or a keep-alive message.

17. An Internet Protocol Security (IPsec) tool comprising:
at least one memory coupled to at least one processor, the at least one memory having program instructions stored thereon that, upon execution by the at least one processor, cause the IPsec tool to:
obtain a plurality of log records associated with a plurality of Security Associations (SAs) that provide intercommunication among a plurality of nodes configured in a cluster, each log record including information about an event associated with its associated SA, wherein the SAs conform to an IP Security (IPsec) protocol;
correlate the log records according to their IP address information, the IP address information uniquely identifying each node in the cluster; and
generate a line graph that visually represents the SAs using a plurality of SA identifiers (SA IDs).

18. The IPsec tool of claim 17, wherein the program instructions, upon execution, further cause IPsec tool to extract, from the log records, at least one of a SA establishment, a SA teardown, a SA timeout, a SA keep-alive message, a SA rekey event, a SA configuration problem, a Service restart, and a node reboot event.

19. The IPsec tool of claim 17, wherein the program instructions, upon execution, further cause IPsec tool to generate an icon proximate to a SA ID, wherein the icon represents an event that the SA experienced.

20. The IPsec tool of claim 19, wherein the program instructions, upon execution, further cause IPsec tool to generate the icon according to how the SA was established or torn down or to indicate event information that the SA has encountered.
